(19) United States
(12) Patent Application Publication
(10) Pub. No.: US 2026/0276525 A1
(43) Pub. Date: Sep. 17, 2026

(54) DETECTION APPARATUS

(71) Applicant: National Institute of Information and Communications Technology, Tokyo (JP)

(72) Inventors: Bahram JALALI, Los Angeles, CA (US); Yuta GOTO, Tokyo (JP); Takeshi MAKINO, Tokyo (JP); Takahiro HASHIMOTO, Tokyo (JP); Naoya WADA, Tokyo (JP); Hideaki FURUKAWA, Tokyo (JP)

(73) Assignee: National Institute of Information and Communications Technology, Tokyo (JP)

(21) Appl. No.: 19/076,012

(22) Filed: Mar. 11, 2025

(51) Int. Cl. G01N 15/1434; G01N 15/10

(52) U.S. Cl. CPC G01N 15/1436; G01N 2015/1006

(57) ABSTRACT

A detection apparatus includes: a light source configured to output, as signal light, multiwavelength light containing a plurality of wavelengths; an irradiation unit configured to irradiate a measurement target that is to be detected with the signal light; a first separation unit configured to generate first light by separating scattered light into individual wavelengths, the scattered light being the signal light scattered by the measurement target; a second separation unit configured to generate second light by separating the signal light into individual wavelengths; an amplifier configured to generate third light by superimposing, for each wavelength, the first light and the second light; and an identifier configured to identify the measurement target, based on the third light.

### TECHNICAL FIELD

The present disclosure relates to a detection apparatus.

### BACKGROUND ART

A technique has been proposed to evaluate the properties of a sample by irradiating the sample with light and analyzing the intensity of the light scattered by the sample (see Non-Patent Document 1).

### DOCUMENT OF RELATED ART

### Non-Patent Document

[Non-Patent Document 1] Adam, J., Mahjoubfar, A., Diebold, E. D., Buckley, B. W., & Jalali, B. (2013). Spectrally encoded angular light scattering. Optics express, 21(23), 28960-28967

### SUMMARY

### Problems to be Solved

For example, a photomultiplier tube may be employed to enhance the sensitivity of a detection apparatus that detects properties of a sample by irradiation. However, photomultiplier tubes are prone to thermal noise or the like.

One aspect of disclosure of the technique aims to provide a highly sensitive detection apparatus with improved noise resistance.

### Means for solving the Problems

One aspect of disclosure of the technique is exemplified by the following detection apparatus. The detection apparatus includes: a light source configured to output, as signal light, multiwavelength light containing a plurality of wavelengths; an irradiation unit configured to irradiate a measurement target that is to be detected with the signal light; a first separation unit configured to generate first light by separating scattered light into individual wavelengths, the scattered light being the signal light scattered by the measurement target; a second separation unit configured to generate second light by separating the signal light into individual wavelengths; an amplifier configured to generate third light by superimposing, for each wavelength, the first light and the second light; and an identifier configured to identify the measurement target, based on the third light.

### Effects

The disclosed technique can provide a highly sensitive detection apparatus with improved noise resistance.

### BRIEF DESCRIPTION OF THE DRAWINGS

FIG. 1 is a diagram illustrating an example of a detection apparatus according to an embodiment;

FIG. 2 is a diagram for explaining how a time-stretch fiber maps different wavelengths of light to different points along the time axis;

FIG. 3 is a diagram for explaining how a time-stretch fiber maps different wavelengths of light to different points along the time axis;

FIG. 4 is a schematic diagram illustrating light superposition in an optical fiber;

FIG. 5 is a diagram illustrating an example of a flow cell according to a practical example;

FIG. 6 is a diagram illustrating an example of a detection apparatus according to a first practical example;

FIG. 7 is a diagram illustrating an example of a detection apparatus according to a second practical example;

FIG. 8 is a diagram illustrating an example of a detection apparatus according to a third practical example; and

FIG. 9 is a diagram illustrating an example of a detection apparatus according to a fourth practical example.

### DETAILED DESCRIPTION

### Embodiments

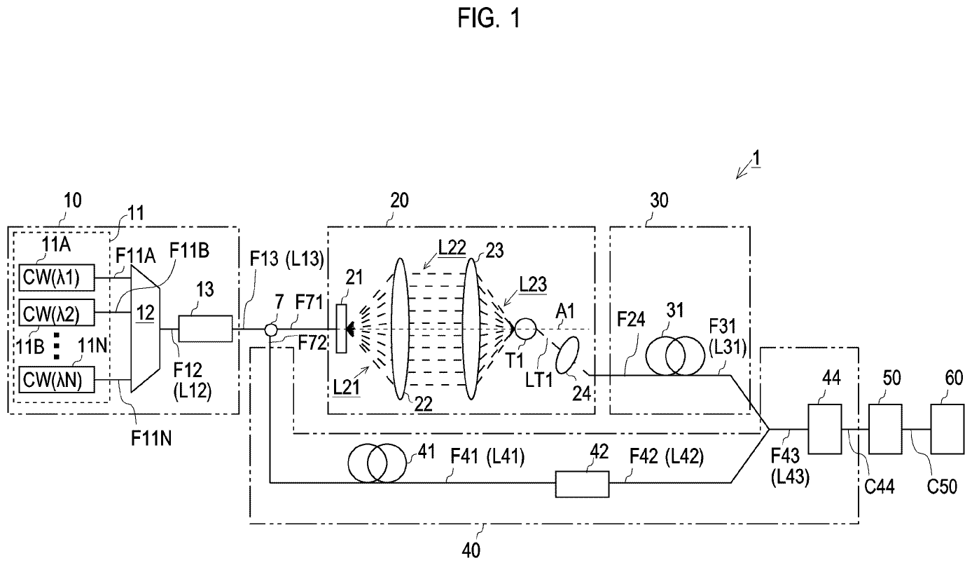

Embodiments will be described below with reference to the drawings. FIG. 1 is a diagram illustrating an example of the detection apparatus 1. The detection apparatus 1 includes a light source 10, a dispersion unit 20, a separation unit 30, a coherent receiver 40, an oscilloscope 50, and a signal processor 60. The detection apparatus 1 irradiates particles T1 with multiwavelength light emitted from the light source 10, and detects the particles T1 using the light scattered by the particles T1.

The particles T1 that are the target to be detected by the detection apparatus 1 can be, for example, components of blood (red blood cells, white blood cells, platelets, etc.), cells, viruses, and the like. The particles T1 may also be chemicals, or food.

The light source 10 includes a laser unit 11, an arrayed waveguide grating (AWG) 12, and a gate 13. The laser unit 11 includes lasers 11A, 11B, ..., and 11N (N being a natural number) that emit laser beams of different wavelengths. The laser 11A emits a laser beam (CW(λ1)) with a wavelength of λ1. The laser 11B emits a laser beam (CW(λ2)) with a wavelength of λ2. The laser 11N emits a laser beam (CW(λN)) with a wavelength of λN. The lasers 11A, 11B, ..., and 11N are connected to the AWG 12 via optical fibers F11A, F11B, ..., and F11N. Laser beams emitted from the lasers 11A, 11B, ..., and 11N enter the AWG 12. The lasers 11A, 11B, ..., and 11N emit laser beams of the same intensity. The laser beams emitted from the lasers 11A, 11B, ..., and 11N are, for example, continuous light.

The AWG 12 generates multiwavelength light L12 by superimposing the laser beams (CW(λ1)), (CW(λ2)), ..., and (CW(λN)) entering from the lasers 11A, 11B, ..., and 11N. The multiwavelength light L12 is light that contains multiple wavelengths λ1, λ2, ..., and λN superimposed at the same point in time. Since the laser beams (CW(λ1)), (CW(λ2)), ..., and (CW(λN)) from the lasers 11A, 11B, ..., and 11N are continuous light, the multiwavelength light L12 is also continuous light. The AWG 12 is connected to the gate 13 via an optical fiber F12. The AWG 12 transmits the multiwavelength light L12 into the gate 13 via the optical fiber F12. The AWG 12 is an example of a “generation unit.”

The gate 13 generates pulsed light L13 by dividing the multiwavelength light L12 with a predetermined frequency. The predetermined frequency is, for example, 1 GHz. Since the multiwavelength light L12 contains multiple wavelengths λ1, λ2, ..., and λN superimposed at the same point in time, the pulsed light L13 also contains multiple wavelengths λ1, λ2, ..., and λN superimposed at the same point in time. The gate 13 is connected to a splitter 7 via an optical fiber F13. The generated pulsed light L13 is transmitted to the splitter 7 via the optical fiber F13. The pulsed light L13 is an example of “signal light.”

The splitter 7 is connected to a dispersive element 21 of the dispersion unit 20 via an optical fiber F71. The splitter 7 is connected to a time-stretch fiber 41 of the coherent receiver 40 via an optical fiber F72. The splitter 7 splits the pulsed light L13 entering from the AWG 12 into the optical fibers F71 and F72. A fiber coupler, for example, is employed as the splitter 7.

The dispersion unit 20 includes the dispersive element 21, and lenses 22, 23, and 24. The dispersive element 21 and the lenses 22 and 23 are disposed such that they have the same optical axis A1. The dispersive element 21 and the lenses 22, 23, and 24 are spatially coupled to each other. The particles T1 that are to be detected by the detection apparatus 1 are placed between the lens 23 and the lens 24. The lenses 22, 23, and 24 are, for example, convex lenses.

The dispersive element 21 disperses the incident pulsed light L13 from the optical fiber F71 into individual wavelengths, producing dispersed light L21. A prism, for example, can be employed as the dispersive element 21. The dispersed light L21 produced by the dispersive element 21 enters the lens 22. The dispersive element 21 is an example of an “optical element.”

The lens 22 collimates the dispersed light produced by the dispersive element 21 into parallel light beams L22. The parallel light beams L22 are parallel rays of the light of the wavelengths λ1, λ2, ..., and λN contained in the pulsed light L13. The parallel light beams L22 enter the lens 23.

The lens 23 irradiates the particles T1 with the light L23 that is focused from the parallel light beam L22. The particles T1 are placed, for example, at the focal point of the lens 23. The light L23 is scattered by the particles T1. Part of the scattered light LT1 enters the lens 24. The light is scattered by the particles T1 at different angles depending on the wavelength. Therefore, each wavelength of the scattered light LT1 entering lens 24 has a different intensity. The lens 24 directs the incident scattered light LT1 into the separation unit 30. The lens 24 is positioned, for example, where the backscatter of light from the particles T1 does not reach (outside the backscatter range). The dispersion unit 20 is an example of an “irradiation unit.”

The separation unit 30 includes an optical fiber F24, a time-stretch fiber 31, and an optical fiber F31. The optical fiber F24 is connected to the time-stretch fiber 31. The optical fiber F24 is, for example, spatially coupled to the lens 24. The optical fiber F31 is connected to the time-stretch fiber 31, and to an optical fiber F43 of the coherent receiver 40.

The scattered light LT1 enters the optical fiber F24 through the lens 24. The scattered light LT1 entering the optical fiber F24 is light that contains multiple wavelengths λ1, λ2, ..., and λN superimposed at the same point in time. The scattered light LT1 enters the time-stretch fiber 31 via the optical fiber F24. The time-stretch fiber 31 is an optical fiber that causes each wavelength of light to propagate at a different velocity. The time-stretch fiber 31 maps the multiple wavelengths λ1, λ2, ..., and λN superimposed at the same point in time to different points along the time axis.

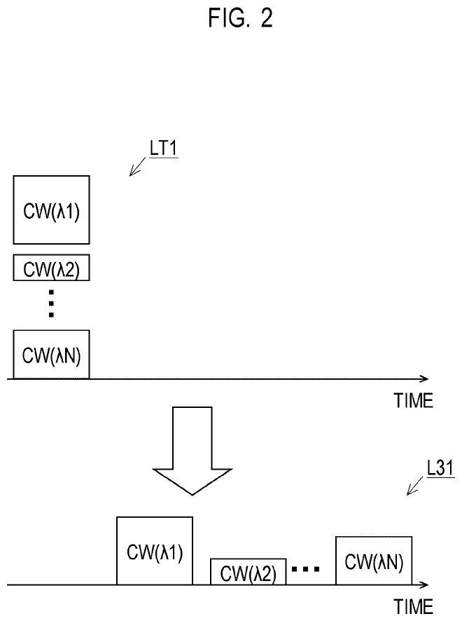

FIG. 2 is a diagram explaining how a time-stretch fiber 31 maps different wavelengths of light to different points along the time axis. FIG. 2 shows the intensity of each light as represented by the height of the rectangles, each corresponding to the light (CW(λ1)) with wavelength λ1, light (CW(λ2)) with wavelength λ2, ..., and light (CW(λN)) with wavelength λN. FIG. 2 shows the scattered light LT1 in the upper part, before it enters the time-stretch fiber 31. The scattered light LT1 contains the multiple wavelengths λ1, λ2, ..., and λN superimposed at the same point in time. Each wavelength in the scattered light LT1 has a different intensity (amplitude) due to scattering by the particles T1.

FIG. 2 in the lower part shows the light L31, after it entered the time-stretch fiber 31. The light L31 has the wavelengths λ1, λ2, ..., and λN mapped to different points along the time axis. The light L31 containing the wavelengths λ1, λ2, ..., and λN mapped to different points along the time axis by the time-stretch fiber 31 enters the optical fiber F43 via the optical fiber F31. The time-stretch fiber 31 is an example of “a first separation unit.” The light L31 is an example of “first light.”

Meanwhile, the pulsed light L13, split into the optical fiber F72 by the splitter 7, enters the time-stretch fiber 41 of the coherent receiver 40. The coherent receiver 40 includes the optical fiber F72, time-stretch fiber 41, optical fiber F41, a phase adjuster 42, optical fibers F42 and F43, and a photodetector 44. The optical fiber F72 is connected to the splitter 7 and time-stretch fiber 41. The optical fiber F41 is connected to the time-stretch fiber 41 and phase adjuster 42. The optical fiber F42 is connected to the phase adjuster 42 and optical fiber F43. The optical fiber F43 is connected to the optical fiber F42, photodetector 44, and to the optical fiber F31 of the separation unit 30.

The time-stretch fiber 41 has a similar configuration as that of the time-stretch fiber 31, and maps the wavelengths λ1, λ2, ..., and λN superimposed at the same point in time in the pulsed light L13 to different points along the time axis.

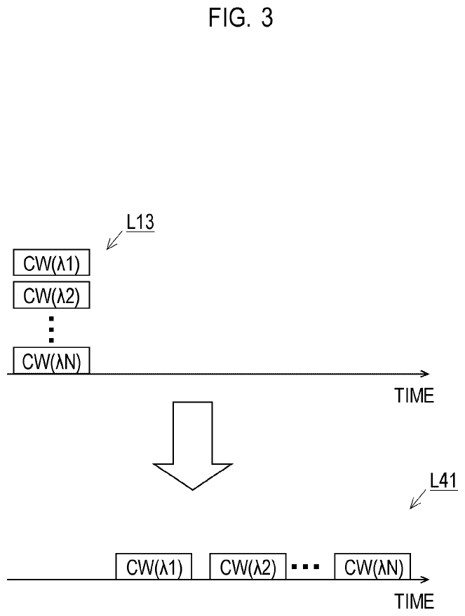

FIG. 3 is a diagram explaining how the time-stretch fiber 41 maps different wavelengths of light to different points along the time axis. FIG. 3 shows the intensity of each light as represented by the height of the rectangles, each corresponding to the light (CW(λ1)) with wavelength λ1, light (CW(λ2)) with wavelength λ2, ..., and light (CW(λN)) with wavelength λN. FIG. 3 shows the pulsed light L13 in the upper part, before it enters the time-stretch fiber 41. The pulsed light L13 contains the multiple wavelengths λ1, λ2, ..., and λN superimposed at the same point in time. Since the light L41 has not been scattered by the particles T1, each wavelength in the light has more or less the same intensity (amplitude).

FIG. 3 in the lower part shows the light L41, after it entered the time-stretch fiber 41. It can be seen that the wavelengths λ1, λ2, ..., and λN are mapped to different points along the time axis in the light L41. The light L41 containing the wavelengths λ1, λ2, ..., and λN mapped to different points along the time axis by the time-stretch fiber 41 enters the phase adjuster 42 via the optical fiber F41. The time-stretch fiber 41 is an example of “a second separation unit.” The light L41 is an example of “second light.”

Referring back to FIG. 1, the phase adjuster 42 adjusts the phase of the light L41. A phase shift can occur between the light split at the splitter 7 into the optical fiber F71 and into the optical fiber F72, as the light travels through different light paths. The phase adjuster 42 adjusts the phase of the light L41 such as to reduce the phase difference, as much as possible, between the light split into the optical fiber F71 and entering the photodetector 44 and the light split into the optical fiber F72 and entering the photodetector 44. Preferably, the phase adjuster 42 adjusts the phase of the light L41 so that phase difference between the light split into the optical fiber F71 and entering the photodetector 44 and the light split into the optical fiber F72 and entering the photodetector 44 is “0”. The phase adjuster 42 may be, for example, an optical fiber having a predetermined length. The phase adjuster 42 is an example of “an adjustment unit.”

There can be a difference in frequency between the light split into the optical fiber F71 and entering the photodetector 44 and the light split into the optical fiber F72 and entering the photodetector 44. Therefore, more preferably, the phase adjuster 42 can be a phase modulator. Light L42 after the phase has been adjusted by the phase adjuster 42 enters the optical fiber F43 via the optical fiber F42.

The light L31 and the light L42 enter the optical fiber F43. After the phase adjustment by the phase adjuster 42, the phases of the light L31 and the light L42 match each other. The optical fiber F43 is, for example, an optical fiber. The optical fiber F43 superimposes the light L31 and the light L42 to generate light L43.

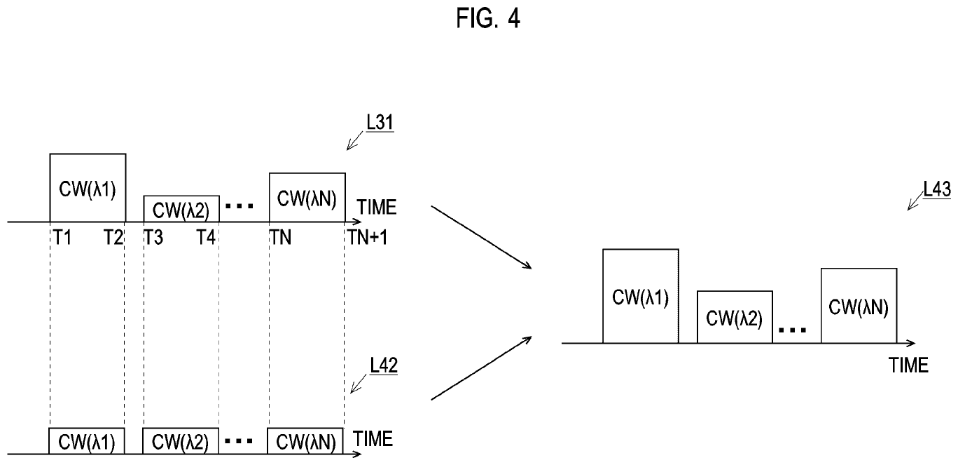

FIG. 4 is a schematic diagram illustrating the light superposition in the optical fiber F43. As described above, the light L31 and the light L42 enter the optical fiber F43. The phases of the light L31 and the light L42 entering the optical fiber F43 have been matched with each other by the phase adjuster 42. Therefore, the time shifts between the wavelengths of each of the light L31 and the light L42 are reduced in the optical fiber F43. In the example shown in FIG. 4, the light L31 with wavelength λ1 and the light L42 with wavelength λ1 correspond to a pulse of light from time T1 to time T2. The light L31 with wavelength λ2 and the light L42 with wavelength λ2 correspond to a pulse of light from time T3 to time T4. The light L31 with wavelength λN and the light L42 with wavelength λN correspond to a pulse of light from time TN to time TN+1.

In the optical fiber F43, the wavelength λ1 in the light L31 and the wavelength λ1 in the light L42 are superimposed into the light L43 with the wavelength λ1. The wavelength λ2 in the light L31 and the wavelength λ2 in the light L42 are superimposed into the light L43 with the wavelength λ2. The wavelength λN in the light L31 and the wavelength λN in the light L42 are superimposed into the light L43 with the wavelength λN. In this way, the light L31 and the light L42 are superimposed for each wavelength to produce the light L43. The light L43 is produced by superimposing the light L42 onto the light L31 through the optical fiber F43, thereby amplifying the intensity of each wavelength in the light L31. The light L43 enters the photodetector 44. The optical fiber F43 is an example of “an amplifier.” The light L43 is an example of “third light.”

Referring back to FIG. 1, the photodetector 44 converts the incident light L43 into an electrical signal. The photodetector 44 converts the light into an electrical signal with a frequency of 100 GHz, for example. The photodetector 44 converts the light into an electrical signal, so that the intensity of each wavelength λ1, λ2, ..., and λN contained in the light L43 is represented by a voltage, for example. The photodetector 44 is connected to the oscilloscope 50 via a cable C44.

The oscilloscope 50 displays a waveform representing the time variation of the electrical signal input from the photodetector 44 via the cable C44. The oscilloscope 50 is connected to the signal processor 60 via a cable C50. The oscilloscope 50 outputs a waveform signal representing the time variation of the electrical signal input from the photodetector 44 to the signal processor 60 via the cable C50.

The signal processor 60 is an information processing device that identifies the type of the particles T1 based on the waveform signal input from the oscilloscope 50. The signal processor 60 includes, for example, a processor, a main storage unit, and an auxiliary storage unit. The processor of the signal processor 60 loads a program to the main storage unit. The program is stored, for example, in the auxiliary storage unit. The processor executes the program loaded to the main storage unit. The signal processor 60 thus implements the process of identifying the particles T1.

The signal processor 60 performs predetermined signal processing to the waveform signal input from the oscilloscope 50, for example, and outputs information relating to the particles T1. The signal processor 60 identifies the type of the particles T1, for example, based on the intensity of each wavelength of light as indicated by the waveform signal input from the oscilloscope 50. The oscilloscope 50 and signal processor 60 are an example of “an identifier.”

### Advantageous Effects

In an example embodiment, the pulsed light L13 output from the light source 10 is split at the splitter 7 into light traveling to a first path 71 and light traveling to a second path 72. The light directed to the first path 71 is scattered by the particles T1 and enters the time-stretch fiber 31. The time-stretch fiber 31 maps the wavelengths λ1, λ2, ..., and λN of light to different points along the time axis to produce light L31. The light directed to the second path 72 enters the time-stretch fiber 41, which maps the wavelengths λ1, λ2, ..., and λN of light to different points along the time axis to produce light L41. The optical fiber F43 superimposes the light L31 that has traveled through the time-stretch fiber 31 with the light L42 that has traveled through the time-stretch fiber 41 and phase adjuster 42. The light L31 is part of the light scattered by the particles T1 and expected to be low in intensity. Thus, the low intensity can be supplemented by superimposing the light L31 and L42, as shown in this example embodiment. Consequently, the detection apparatus 1 can detect the particles T1 with greater sensitivity.

An example embodiment adopts lasers 11A, 11B, ..., and 11N as the light source 10. Lasers emit light with a higher intensity than a broadband light source at each wavelength. Therefore, the detection apparatus 1 according to an example embodiment can detect the particles T1 with greater sensitivity. According to an example embodiment, the detection sensitivity of particles T1 can be enhanced without using a photomultiplier tube, which has low noise resistance. Thus the detection apparatus 1 has higher noise resistance than one that uses a photomultiplier tube.

In an example embodiment, the phase adjuster 42 adjusts the phase of the light L42 such as to reduce or eliminate the phase difference between the light L31 that has traveled through the time-stretch fiber 31 and the light L42 that has traveled through the time-stretch fiber 41. As a result, the light L31 and the light L42 are superimposed in the optical fiber F43 without any shift between their respective wavelengths.

Lasers emit monochromatic light. Some embodiments adopt lasers 11A, 11B, ..., and 11N that each emit light at a different wavelength as the light source 10. Therefore, the light source can produce multiwavelength light containing a plurality of wavelengths as a whole, even though each laser emits monochromatic light. Moreover the light can be emitted at a plurality of wavelengths to the particles T1 at the same time. Compared to irradiating particles T1 with wavelengths λ1, λ2, ..., and λN successively, one wavelength at a time, a high throughput can be achieved.

Moreover, in some embodiments, the light L43, which is obtained by amplifying the intensity of each wavelength in the light L31, is used to detect the particles T1. This allows the molar mass, size, concentration etc. of the particles T1 to be determined with high precision.

### Practical Examples

Some practical examples of the above embodiment will be described below in more specific terms. In the practical examples, particles T1 flowing with a sheath fluid inside a flow cell are the target of detection. The flow cell used in the practical examples will be described.

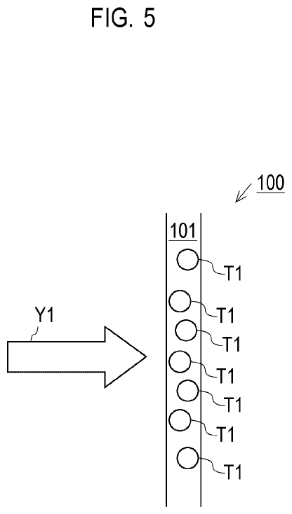

FIG. 5 is a diagram illustrating an example of the flow cell 100 according to a practical example. Particles T1 flow with a sheath fluid inside a flow path 101 of the flow cell 100. The light used for the detection of the particles T1 is projected from the direction of arrow Y1. Inside the flow path 101, the particles T1 in the sheath fluid flow in single file as viewed from the direction of arrow Y1. Such a flow inside the flow path 101 allows the detection apparatus 1 to detect the particles T1 one by one. The detection apparatus 1 in which such flow cell 100 is applied can be called a flow cytometer.

### First Practical Example

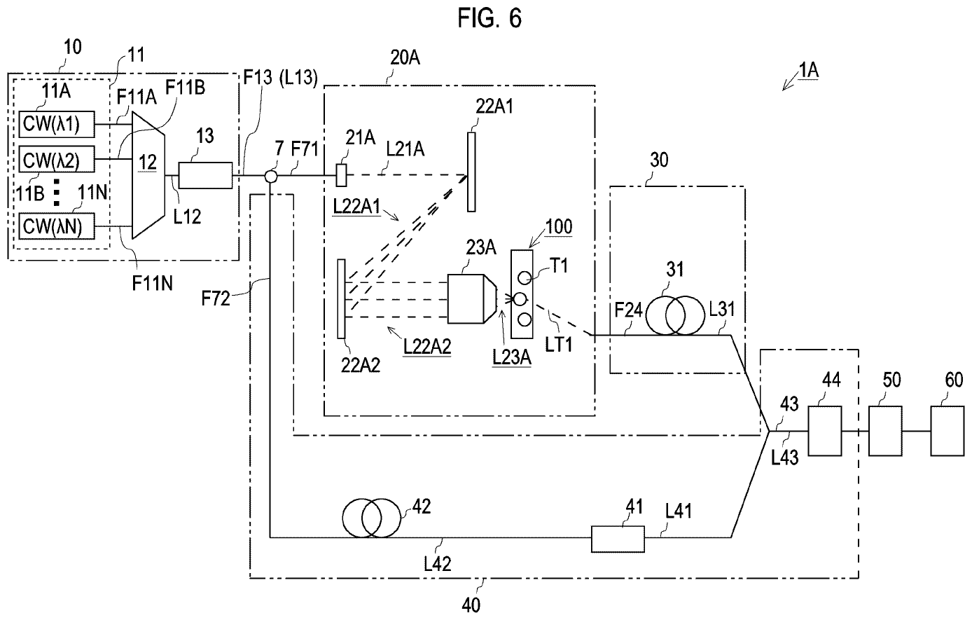

FIG. 6 is a diagram illustrating an example of a detection apparatus 1A according to a first practical example. The detection apparatus 1A differs from the detection apparatus 1 according to the embodiment in that it has a dispersion unit 20A instead of the dispersion unit 20. Particles T1 to be detected flow with a sheath fluid inside a flow cell 100 in the detection apparatus 1A.

The dispersion unit 20A includes a collimator 21A instead of the dispersive element 21, diffraction gratings 22A1 and 22A2 instead of the lenses 22 and 23, and an object lens 23A instead of the lens 24. The pulsed light L13 from the gate 13 enters the collimator 21A via the optical fiber F71.

The collimator 21A generates light L21A by directing the light entering from the gate 13 to travel toward the diffraction grating 22A1. The generated light L21A is emitted toward the diffraction grating 22A1. The diffraction grating 22A1 diffracts the light L21A and directs the diffracted light L22A1 to the diffraction grating 22A2. The diffraction grating 22A2 directs the diffracted light L22A2, which is the diffracted light of the diffracted light L22A1, to the object lens 23A. The diffracted light L22A2, after diffraction of the light L21A and light L22A2, becomes parallel rays of light with the wavelengths λ1, λ2, ..., and λN being parallel to each other.

The object lens 23A is arranged such that its focal point is located at a predetermined position in the flow cell 100. The object lens 23A focuses the diffracted light L22A2 and irradiates the particles T1 with the focused light L23A as they flow through the predetermined position inside the flow cell 100. The particles T1 flow sequentially through the flow cell 100. Therefore, the detection apparatus 1A detects the particles T1 one by one. The particles T1 scatter the projected light L23A. Part of the scattered light LT1 enters the optical fiber F24.

In the first practical example, diffraction gratings 22A1 and 22A2 are used instead of lenses 22 and 23, to produce parallel light beams of diffracted light L22A2 to be directed to the object lens 23A. As shown, elements that produce parallel light beams are not limited to lenses 22 and 23, but can also be diffraction gratings 22A1 and 22A2.

### Second Practical Example

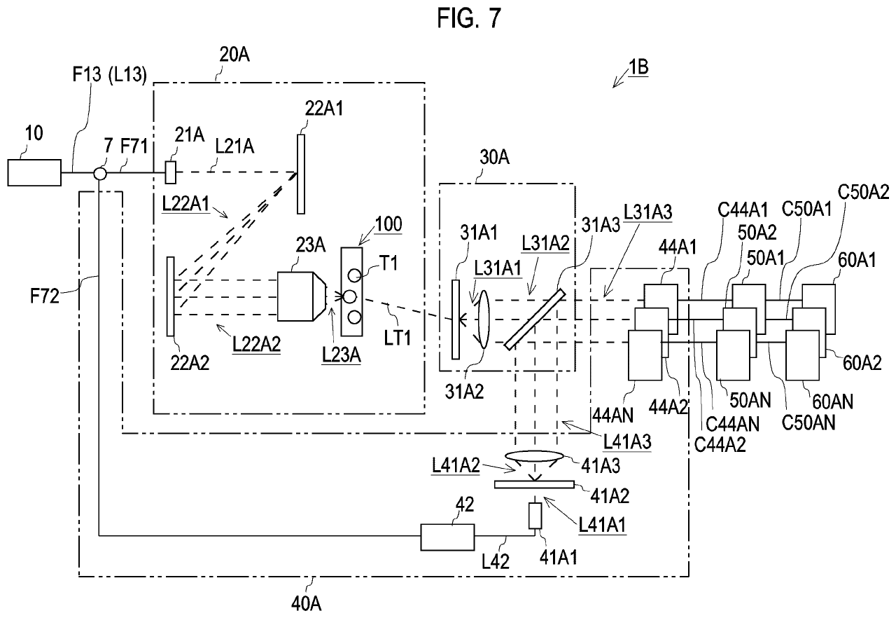

FIG. 7 is a diagram illustrating an example of a detection apparatus 1B according to a second practical example. The detection apparatus 1B differs from the detection apparatus 1A according to the first practical example in that it includes a separation unit 30A, a coherent receiver 40A, oscilloscopes 50A1, 50A2, ..., and 50AN, and signal processors 60A1, 60A2, ..., and 60AN instead of the separation unit 30, coherent receiver 40, oscilloscope 50, and signal processor 60.

The separation unit 30A includes a diffraction grating 31A1, a lens 31A2, and a half mirror 31A3 instead of the time-stretch fiber 31. Scattered light LT1 scattered by the particles T1 enters the diffraction grating 31A1. The diffraction grating 31A1 diffracts the light entering from one side and emits it from the other. The diffraction grating 31A1 diffracts each wavelength at a different angle. Therefore, the diffraction grating 31A1 spatially separates the multiwavelength scattered light LT1 into individual wavelengths, and directs the resulting light L31A1 to the lens 31A2.

The lens 31A2 refracts the incident light L31A1, to direct parallel light beams L31A2 of respective wavelengths in the light L31A1 to the half mirror 31A3.

Meanwhile, the phase adjuster 42 in the coherent receiver 40A adjusts the phase of the light L42, which then travels to a diffraction grating 41A2 via an optical connector 41A1. Similarly to the diffraction grating 31A1, the diffraction grating 41A2 diffracts the light entering from one side and emits it from the other. The diffraction grating 41A2 diffracts and spatially separates the incident light L41A1 into individual wavelengths, and directs the resulting light L41A2 to a lens 41A3.

The lens 41A3 refracts the incident light L41A2, to direct parallel light beams L41A3 of respective wavelengths in the light L41A2 to the half mirror 31A3.

The half mirror 31A3 superimposes the parallel beams L31A2 and the parallel beams L41A3 and directs the resulting light L31A3, one wavelength each to a different one of photodetectors 44A1, 44A2, ..., and 44AN. For example, the light with wavelength λ1 contained in the light L31A3 is directed to the photodetector 44A1. The light with wavelength λ2 is directed to the photodetector 44A2. The light with wavelength λN is directed to the photodetector 44AN.

The photodetector 44A1 converts the light with wavelength λ1 into an electrical signal. The photodetector 44A1 outputs the converted electrical signal to the signal processor 60A1 via a cable C50A1. The photodetector 44A2 converts the light with wavelength λ2 into an electrical signal. The photodetector 44A2 outputs the converted electrical signal to the signal processor 60A2 via a cable C50A2. The photodetector 44AN converts the light with wavelength λN into an electrical signal. The photodetector 44AN outputs the converted electrical signal to the signal processor 60AN via a cable C50AN.

The oscilloscope 50A1 displays a waveform representing the time variation of the electrical signal input from the photodetector 44A1 via a cable C44A1. The oscilloscope 50A1 is connected to the signal processor 60A1 via the cable C50A1. The oscilloscope 50A1 outputs a waveform signal representing the time variation of the electrical signal input from the photodetector 44A1 to the signal processor 60A1 via the cable C50A1.

The oscilloscope 50A2 displays a waveform representing the time variation of the electrical signal input from the photodetector 44A2 via a cable C44A2. The oscilloscope 50A2 is connected to the signal processor 60A2 via the cable C50A2. The oscilloscope 50A2 outputs a waveform signal representing the time variation of the electrical signal input from the photodetector 44A2 to the signal processor 60A2 via the cable C50A2.

The oscilloscope 50AN displays a waveform representing the time variation of the electrical signal input from the photodetector 44AN via a cable C44AN. The oscilloscope 50AN is connected to the signal processor 60AN via the cable C50AN. The oscilloscope 50AN outputs a waveform signal representing the time variation of the electrical signal input from the photodetector 44AN to the signal processor 60AN via the cable C50AN.

The signal processor 60A1 performs predetermined signal processing to the waveform signal input from the oscilloscope 50A1, and outputs information relating to the particles T1. The signal processor 60A2 performs predetermined signal processing to the waveform signal input from the oscilloscope 50A2, and outputs information relating to the particles T1. The signal processor 60AN performs predetermined signal processing to the waveform signal input from the oscilloscope 50AN, and outputs information relating to the particles T1. In the second practical example, the type of the particles T1 is identified based on the information output from each of the signal processors 60A1, 60A2, ..., and 60AN.

In the second practical example, the pulsed light L13 is spatially separated into individual wavelengths by the diffraction grating 31A1, lens 31A2, diffraction grating 41A2, and lens 41A3. Namely, the multiwavelength pulsed light L13 can be separated into individual wavelengths not only in time (as in the embodiment and first practical example), but also in space. The second practical example uses the spatial separation of light and is therefore equipped with photodetectors 44A1, 44A2, ..., and 44AN, oscilloscopes 50A1, 50A2, ..., and 50AN, and signal processors 60A1, 60A2, ..., and 60AN, each corresponding to each of the wavelengths contained in the pulsed light L13.

### Third Practical Example

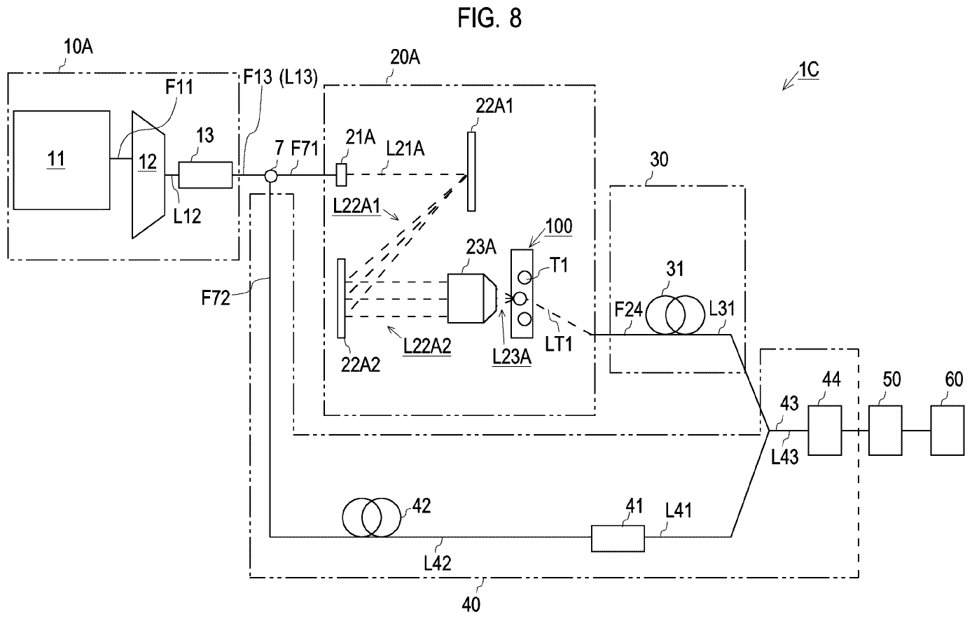

FIG. 8 is a diagram illustrating an example of a detection apparatus 1C according to a third practical example. The detection apparatus 1C differs from the detection apparatus 1A according to the first practical example in that it has a light source 10A instead of the light source 10.

The light source 10A includes a broadband light source 111 instead of the lasers 11A, 11B, ..., and 11N. The broadband light source 111 is a light source that emits light over a wide range of wavelengths. Namely, the broadband light source 111 emits light over a wide range of wavelengths from a single light source, rather than emitting multiwavelength light from a combination of light sources each emitting a laser beam at a different wavelength. The broadband light emitted by the broadband light source 111 contains a continuous range of wavelengths. On the other hand, the wavelengths in the multiwavelength light emitted by the light source 10 are discontinuous. For example, a super luminescent diode (SLD) light source, which emits pulsed light over a broad spectrum, can be used as the broadband light source 111. Alternatively, an amplified spontaneous emission (ASE) light source, or a super continuum (SC) light source, which emits continuous light over a broad spectrum, can be used as the broadband light source 111.

As shown in the third practical example, the light source that can be used in the detection apparatus 1 is not limited to lasers. However, lasers are preferred to SLDs as the light source of the detection apparatus 1, as the latter has a lower power output than the former.

### Fourth Practical Example

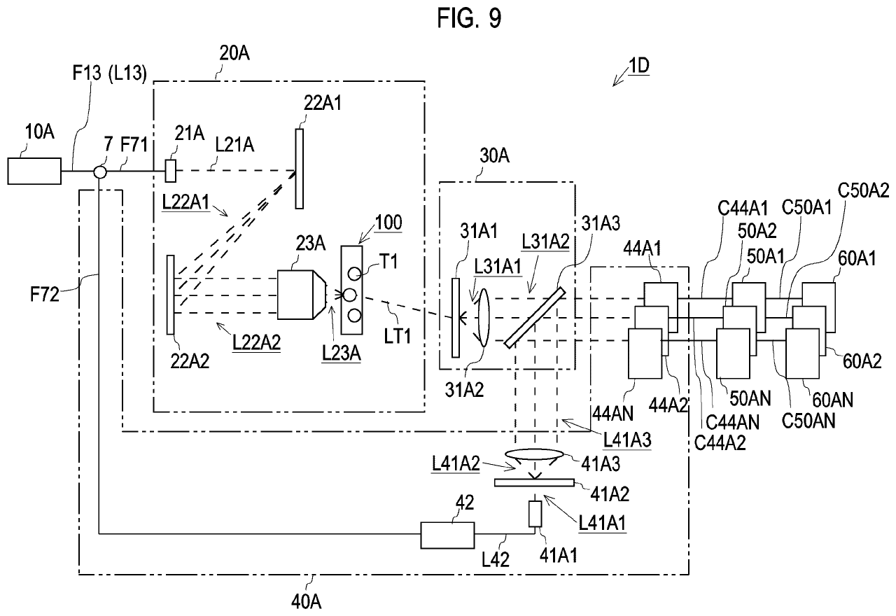

FIG. 9 is a diagram illustrating an example of a detection apparatus 1D according to a fourth practical example. The detection apparatus 1D differs from the detection apparatus 1B according to the second practical example in that it has the light source 10A instead of the light source 10.

As shown by the fourth practical example, a broadband light source can be used as the light source 10A in the case where light is spatially separated into individual wavelengths using the diffraction grating 31A1, lens 31A2, diffraction grating 41A2, and lens 41A3.

The above-described embodiments and practical examples can be variously combined.

What is claimed is:

1. A detection apparatus comprising:
a light source configured to output, as signal light, multiwavelength light containing a plurality of wavelengths;
an irradiation unit configured to irradiate a measurement target that is to be detected with the signal light;
a first separation unit configured to generate first light by separating scattered light into individual wavelengths, the scattered light being the signal light scattered by the measurement target;
a second separation unit configured to generate second light by separating the signal light into individual wavelengths;
an amplifier configured to generate third light by superimposing, for each wavelength, the first light and the second light; and
an identifier configured to identify the measurement target, based on the third light.

2. The detection apparatus according to claim 1, further comprising
an adjustment unit configured to match phases of the first light and the second light, wherein
the amplifier is configured to generate the third light by superimposing, for each wavelength, the first light and the second light after the phases are matched by the adjustment unit.

3. The detection apparatus according to claim 1, wherein
the first separation unit and the second separation unit include a time-stretch fiber configured to cause light to propagate at different speeds depending on wavelength.

4. The detection apparatus according to claim 1, wherein
the first separation unit and the second separation unit include a diffraction grating and a lens.

5. The detection apparatus according to claim 1, wherein
the irradiation unit comprises:
an optical element configured to spatially separate the signal light into individual wavelengths; and
a lens configured to focus and radiate light onto the measurement target after the light has been spatially separated into individual wavelengths by the optical element.

6. The detection apparatus according to claim 5, wherein
the optical element includes a prism.

7. The detection apparatus according to claim 5, wherein
the optical element includes a diffraction grating.

8. The detection apparatus according to claim 1, wherein
the light source includes:
a plurality of laser light sources each configured to emit light at a different wavelength; and
a generation unit configured to generate the signal light by superimposing light emitted from the plurality of laser light sources.

9. The detection apparatus according to claim 1, wherein
the light source includes a broadband light source configured to emit light containing the plurality of wavelengths.

10. The detection apparatus according to claim 1, wherein
the measurement target flows inside a flow path of a flow cell, and
the irradiation unit irradiates a predetermined location of the flow path with the signal light.
